(19) United States
(12) Patent Application Publication
(10) Pub. No.: US 2009/0166582 A1
(43) Pub. Date: Jul. 2, 2009

(54) CALCIUM CHLORIDE SOLUTION HAVING IMPROVED CORROSION RESISTANCE

(75) Inventors: Robert A. Hartley, Ontario (CA); David H. Wood, Rome, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignees: Sears Petroleum & Transport Corporation, Rome, NY (US); SearsEcological Applications Co., LLC, Rome, NY (US)

(21) Appl. No.: 12/342,852

(22) Filed: Dec. 23, 2008

Related U.S. Application Data
(60) Provisional application No. 61/016,945, filed on Dec. 27, 2007.

(51) Int. Cl. C09K 3/00

(52) U.S. Cl. 252/182.32

(57) ABSTRACT

A brine solution which includes calcium chloride and water and an effective amount of a corrosion inhibitor and solution stabilizer in the form of a low molecular weight carbohydrate having a molecular weight in the range of about 180 to 342. The carbohydrate may be any one of glucose, galactose, fructose, sorbose, sucrose, maltose and lactose and mixtures thereof.

### CROSS-REFERENCE TO RELATED APPLICATION

This application claims priority to and the benefit of U.S. Provisional Patent Application Ser. No. 61/016,945, filed Dec. 27, 2007, and entitled CALCIUM CHLORIDE SOLUTION HAVING IMPROVED CORROSION RESISTANCE, which application is incorporated herein by this reference.

### BACKGROUND OF THE INVENTION

The present invention relates in general to salt and brine solutions, and more specifically to calcium chloride solutions.

Calcium chloride has long been known for use in solutions for roadway deicing, as a concrete additive, drilling mud additive and for dust suppression.

A common problem associated with calcium chloride is that it is extremely corrosive to metal surfaces and adversely affects roadside vegetation and water. There have been many attempts over the years to add various anti-corrosive agents to calcium chloride solutions in order to reduce these corrosive effects.

One problem associated with calcium chloride solutions is that they have a tendency to precipitate anti-corrosive agents out of solution and render them ineffective for their intended purpose. There has therefore been a continuing need for an anti-corrosive agent which readily remains in solution with calcium chloride in order to carry out its intended use.

U.S. Pat. No. 1,824,588 teaches the use of a mixture of calcium chloride and magnesium chloride in a solution for use as a dust control formulation. The invention relates to the discovery that calcium chloride, in combination with a critical amount of magnesium chloride and water, results in a superior dust control solution having improved hygroscopic properties.

U.S. Pat. No. 5,296,167 is directed to the concept of inhibiting corrosion of metal in an aqueous solution of calcium chloride which involves incorporating in the calcium chloride solution an alkali metal or alkaline earth metal orthophosphate which comprises from 10 to 60% dihydrogen phosphate and from 90 to 40% mono-hydrogen phosphate in an amount of about 0.7 to 5 weight percent of the aqueous calcium chloride solution. The patent states that with respect to the orthophosphate, there is a limited dissolution rate of the orthophosphate and some additional preparation time may be required to complete solubility of the orthophosphate in the calcium chloride liquid solution.

U.S. Pat. No. 6,616,739 recognizes the corrosion problem associated with chloride salts and teaches the use of calcium chloride as a preferred example. The patent teaches that honey is an effective and practical anti-corrosive agent for chloride salts, and in particular for calcium chloride and magnesium chloride. The patent states that it has been discovered that the presence of honey provides an anti-corrosive effect in accordance with the invention, and that the unique attributes contributed by the honey are due to the presence and/or quantity levels not found in other sweetener constituents, which include acids, minerals, proteins, flavoroids that contain large quantities of anti-oxidants, and honey enzymes.

U.S. Publication 2004/0191401 relates to a method for treating a particulate and for dust and erosion control in which the composition includes a dissolved sugar solid in combination with a salt such as calcium chloride or a lignin or combinations thereof. In paragraph [0016] it is specifically stated that the sugar water solution has about 15 to 80 percent of dissolved sugar, and that the dissolved sugar comprises about 2 to 60 percent by weight of a monosaccharide, and a salt.

### SUMMARY OF THE INVENTION

The present invention is based upon the discovery that a select group of low molecular weight carbohydrates provides a significant anti-corrosive effect on calcium chloride containing brine solutions. In addition it has been found that these carbohydrates also provide stability for calcium chloride solutions which have a tendency to form precipitates rendering the solution ineffective for its intended purpose.

The carbohydrates suitable for use in the present invention have a molecular weight in the range of about 180 to 342 and include glucose, galactose, fructose, sorbose, sucrose, maltose and lactose. A preferred group which exhibit superior properties as corrosion inhibitors for calcium chloride solutions include the group of ketose sugars which include fructose and sorbose.

### DETAILED DESCRIPTION OF THE INVENTION

A series of test were carried out to determine the corrosion rate of various salt/brine solutions and the effect of various low molecular weight carbohydrates on reducing the corrosion rate of these solutions. In Table I a 24% calcium chloride salt solution was tested for its corrosion rate with three separate low molecular weight carbohydrates. The results are tabulated below.

TABLE I

| | Concentration | | | |
|---|---|---|---|---|
| | of | Calcium | Corrosion Rate | |
| Carbohydrate | Carbohydrate | Chloride | | Reduction in |
| Tested | Tested | Content | Mils per year | % |
| None | None | 24% | 77.3 | Nil |
| Fructose | 10% | 24% | 22.7 | 70.6 |
| Glucose | 10% | 24% | 30.7 | 60.3 |
| Sucrose | 10% | 24% | 37.7 | 51.2 |

As shown by the data, fructose is superior to glucose and sucrose as a corrosion inhibitor. All three low molecular weight carbohydrates exhibit significant corrosion inhibition.

Two naturally occurring industrial brines, identified below as Brine 1 and Brine 2, respectively, were tested having the following compositions:

TABLE II

| | Brine 1 | Brine 2 |
|---|---|---|
| CaCl₂ | 9.41% | 20.77% |
| MgCl₂ | 2.90% | 4.31% |
| NaCl | 10.16% | 3.56% |
| KCl | 0.59% | 1.49% |

From the above data in Table II it can be seen that the two naturally occurring brines contain various concentrations of CaCl₂, MgCl₂, NaCl and Kcl.

The corrosion rates were determined for various carbohydrate additions in Mils per year and percent reduction in corrosion over the brine containing no carbohydrate additive.

TABLE III

| | Concen- | | | | |
|---|---|---|---|---|---|
| | tration | | Concentration | | |
| | of Brine | | of | Corrosion Rate | |
| | % pb | | Carbohydrate | Mils per | Reduction |
| Brine | volume | Carbohydrate | % pbv | year | in % |
| Brine 1 | 100 | None | None | 56.7 | Nil |
| Brine 1 | 80 | Molasses | 20 | 5.52 | 90.6 |
| Brine 1 | 80 | Casco | 20 | 25.6 | 54.8 |
| Brine 1 | 80 | High | 20 | 16.2 | 71.4 |
| | | Fructose | | | |
| | | Corn Syrup | | | |
| Brine 2 | 100 | None | None | 43.5 | Nil |
| Brine 2 | 80 | Molasses | 20 | 7.58 | 82.6 |
| Brine 2 | 80 | Casco | 20 | 24.2 | 44.4 |

Note:
Casco is a corn DE 42. The high fructose corn syrup is High Sweet 42 from Roquette America Inc. and the low molecular weight carbohydrate distribution by weight in this mixture is: Glucose 8.09% Fructose 6.53% Higher saccharides 0.94%

From the above data it can be seen that the two naturally occurring brines which contain varying ratios of CaCl₂ and MgCl₂ both exhibit a significant reduction in corrosion rate when varying amounts of carbohydrate are added to the brine.

In order to demonstrate the unique effect of certain low molecular weight carbohydrates on the stability of calcium chloride/carbohydrate formulations, the following tests were carried out.

The following comparative test data illustrates the criticality of low molecular weight fraction in overcoming the precipitation problem of the prior art.

| Component | Formulation A | Formulation B |
|---|---|---|
| 43% CaCl₂ aqueous solution | 70 parts by volume | 70 parts by volume |
| High Maltose Corn Syrup | 20 parts by volume | Nil |
| High Fructose Corn Syrup | Nil | 20 parts by volume |
| Water | 10 parts by volume | 10 parts by volume |
| Carbohydrate content in | | |
| above solutions: | | |
| Glucose Mol. Wt. 180 | 1.98% by weight | 7.16% by weight |
| Fructose Mol. Wt. 180 | Nil | 5.78% by weight |
| Maltose Mol. Wt. 342 | 7.07% by weight | 0.41% by weight |
| Maltotriose Mol. Wt. 504 | 3.29% | Nil |
| Higher Saccharides | 4.11% by weight | 0.41% by weight |
| Mol. Wt. Greater than 666 | | |
| Stability | Poor | Excellent |
| | Precipitate formed | No precipitate |
| | | formed |

### Carbohydrate Data

### Formulation A

This used a high maltose corn syrup from Cargill called Clearsweet 43% 1× which had on a solids basis:

| | |
|---|---|
| Glucose 12% by wt. | Mol. Wt. 180 |
| Maltose 43% by wt. | Mol. Wt. 342 |
| Maltotriose 20% by wt. | Mol. Wt. 504 |
| Higher Saccharides 25% by wt. | Mol. Wt. greater than 666 |

This corn syrup had a total solids of 80.9% average and a specific gravity 1.4198.

### Formulation B

This used a high fructose corn syrup from Cargill called IsoClear 42 which had on a solids basis:

| | |
|---|---|
| Fructose 42.0% by wt. | Mol. Wt. 180 |
| Glucose 52.0% by wt. | Mol. Wt. 180 |
| Maltose 3.0% by wt. | Mol. Wt. 342 |
| Higher Saccharides 3.0% by wt. | Mol. Wt. 504 |

This syrup had a total solids of 71% by wt and a specific gravity 1.3372.

### Stability

It can be seen from the above that precipitation occurs in formulations with carbohydrates in a significant concentration which have a molecular weight of 666 and greater (Formulation A). The precipitate formed in a few hours. By contrast, no precipitation occurred in Formulation B which contained a significant amount of low molecular weight carbohydrate (glucose and fructose) and smaller amounts of carbohydrates over 666 in molecular weight than Formulation A.

In one embodiment of the invention, solutions containing 24% calcium chloride and 10% of selected carbohydrates were prepared in distilled water. The selected carbohydrates used are glucose, galactose, fructose, sorbose, sucrose, maltose and lactose. The seven solutions were stored at room temperature and at −17.8° C. for seven days. The results of the tests are tabulated in Table IV.

TABLE IV

| | | | Calcium | | |
|---|---|---|---|---|---|
| Carbohydrate | | | Chloride | | |
| | | Concentration | Concentration | | |
| | Molecular | in Aqueous | in Aqueous | Stability After 7 Days | |
| Name | Weight | Mixture | Mixture | 25° C./77° F. | −17.8° C./0° F. |
| Glucose | 180 | 10.0% | 24.0% | No | No |
| | | | | Precipitate | Precipitate |
| Galactose | 180 | 10.0% | 24.0% | No | No |
| | | | | Precipitate | Precipitate |
| Fructose | 180 | 10.0% | 24.0% | No | No |
| | | | | Precipitate | Precipitate |
| Sorbose | 180 | 10.0% | 24.0% | No | No |
| | | | | Precipitate | Precipitate |
| Sucrose | 342 | 10.0% | 24.0% | No | No |
| | | | | Precipitate | Precipitate |
| Maltose | 342 | 10.0% | 24.0% | No | No |
| | | | | Precipitate | Precipitate |
| Lactose | 342 | 10.0% | 24.0% | No | No |
| | | | | Precipitate | Precipitate |

No indication of instability was observed for any of the test samples. This data shows that certain selected low molecular weight carbohydrates provide stability for calcium chloride aqueous solutions which historically precipitate anti-corrosive agents out of solution rendering the solution ineffective for its intended purpose. It should be understood that the present invention is directed to solutions which typically contain up to about 34% by weight of calcium chloride.

The calcium chloride carbohydrate formulations tested are stable at room temperature and at −17.8° C.

While the present invention has been particularly shown and described with reference to the preferred mode, it will be understood by one skilled in the art that various changes in detail may be effected therein without departing from the spirit and scope of the invention as defined by the claims.

We claim:

1. A brine solution which includes calcium chloride and water and an effective amount of a corrosion inhibitor and solution stabilizer in the form of a ketose sugar.

2. The brine solution of claim 1 in which said solution has the following composition in weight percent:

| | |
|---|---|
| Calcium chloride | 3-35% |
| Ketose sugar | 3-60% |
| Water | balance. |

3. The brine solution of claim 2 in which the ketose sugar is selected from the group consisting of sorbose and fructose.

4. A solution which comprises calcium chloride and water and at least 3% by weight of a ketose sugar, whereby said solution exhibits excellent solubility of the calcium chloride and ketose sugar in said solution.

5. The solution of claim 4 in which said solution has the following composition in weight percent:

| | |
|---|---|
| Calcium chloride | 3-35% |
| Ketose sugar | at least 3% |
| Water | balance. |

6. The solution of claim 5 in which the ketose sugar is selected from the group consisting of sorbose and fructose.

7. A stable solution which comprises 3-35 wt % calcium chloride, at least 3 wt % of a ketose sugar, and the balance water, and where said solution exhibits improved corrosion resistance and improved solubility due to the presence of said ketose sugar.

8. The solution of claim 7 in which said ketose sugar is selected from the group consisting of sorbose and fructose and mixtures thereof.

9. A brine solution which comprises calcium chloride and water and an effective amount of a corrosion inhibitor and solution stabilizer in the form of a carbohydrate which is an aldose sugar.

10. The brine solution of claim 9 in which said solution has the following composition in weight percent:

| | |
|---|---|
| Calcium chloride | 3-35% |
| Carbohydrate | 3-60% |
| Water | balance. |

11. A brine solution which comprises calcium chloride and water and an effective amount of a corrosion inhibitor and solution stabilizer in the form of a ketose sugar in which said solution has the following composition in weight percent:

| | |
|---|---|
| Calcium chloride | 3-35% |
| Ketose sugar | 3-60% |
| Water | balance |

and where the corrosion rate of said brine is in the range of about 6 to 38 mils/yr.

12. The brine solution of claim 11 in which the ketose sugar is selected from the group consisting of sorbose and fructose.

13. A brine solution which comprises calcium chloride and water and an effective amount of a corrosion inhibitor and solution stabilizer in the form of a low molecular weight carbohydrate in which said solution has the following composition in weight percent:

| | |
|---|---|
| Calcium chloride | 3-35% |
| Carbohydrate | 3-60% |
| Water | balance |

and where the molecular weight of said carbohydrate is in the range of 180 to 342.

14. The brine solution of claim 13 in which the corrosion rate of said brine is in the range of about 6 to 38 mils/yr.

15. The brine solution of claim 13 in which the carbohydrate is a maltose and at least one of the group consisting of fructose, glucose and sucrose.

16. A brine solution which includes calcium chloride and water and an effective amount of a corrosion inhibitor and solution stabilizer in the form of an aldose sugar.

17. The brine solution of claim 16 in which said solution has the following composition in weight percent:

| | |
|---|---|
| Calcium chloride | 3-35% |
| Aldose | 3-60% |
| Water | balance. |
